(19) United States
(12) Patent Application Publication
(10) Pub. No.: US 2016/0275181 A1
(43) Pub. Date: Sep. 22, 2016

(54) METHOD OF RELATION ESTIMATION AND INFORMATION PROCESSING APPARATUS

(71) Applicant: FUJITSU LIMITED, Kawasaki-shi (JP)

(72) Inventors: Shohei Yamane, Kawasaki (JP); Fumihito NISHINO, Koto (JP); NOBUYUKI IGATA, Kawasaki (JP)

(73) Assignee: FUJITSU LIMITED, Kawasaki-shi (JP)

(21) Appl. No.: 15/063,899

(22) Filed: Mar. 8, 2016

(30) Foreign Application Priority Data
Mar. 16, 2015 (JP) 2015-052617

(51) Int. Cl. G06F 17/30

(52) U.S. Cl. CPC G06F 17/30684; G06F 17/30696; G06F 17/30705

(57) ABSTRACT

An information processing apparatus extracts records about which a matching relation of pieces of attribute data among records satisfies a certain condition. Based on an extraction result, the information processing apparatus outputs a determination result of an inter-attribute semantic relation.

### CROSS-REFERENCE TO RELATED APPLICATIONS

This application is based upon and claims the benefit of priority of the prior Japanese Patent Application No. 2015-052617, filed on Mar. 16, 2015, the entire contents of which are incorporated herein by reference.

### FIELD

The embodiments discussed herein are related to a method of relation estimation, a relation estimation program, and an information processing apparatus.

### BACKGROUND

Conventionally, a data format has been used that stores therein respective attributes and pieces of attribute data related to the respective attributes in association with each other about a plurality of events. In tabular format data, respective attributes are arranged as respective columns, records are separated by each event, and pieces of attribute data related to the respective attributes of the event are stored in column areas corresponding to the respective attributes, for example.

The data in which respective attributes and pieces of attribute data related to the respective attributes are stored in association with each other in this way is not clear in an inter-attribute semantic relation. In view of this situation, technologies that clarify a semantic relation of data are known. Examples of the technologies include a technology that specifies a semantic relation using concepts of words or ontology indicating relations among words. Conventional technologies are described in Japanese Laid-open Patent Publication No. 2010-262343, Japanese Laid-open Patent Publication No. 2009-169840, and Japanese Laid-open Patent Publication No. 2006-48183, for example.

### SUMMARY

According to an aspect of an embodiment, a method of relation estimation includes: extracting, from a data group that stores therein respective attributes and pieces of attribute data related to the respective attributes in association with each other about a plurality of events, data of events about which a matching relation of the pieces of attribute data among respective events satisfies a certain condition; and based on an extraction result, outputting a determination result of an inter-attribute semantic relation.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of an example of a functional configuration of an information processing apparatus;

FIG. 2 is a diagram of an example of a data configuration of object data;

FIG. 3A is a diagram of an example of a set relation;

FIG. 3B is a diagram of an example of an equivalence relation;

FIG. 3C is a diagram of an example of a hierarchy relation;

FIG. 3D is a diagram of an example of a list relation;

FIG. 3E is a diagram of an example of an irrelevant state;

FIG. 4A is a diagram of an example of the extraction of records having the set relation;

FIG. 4B is a diagram of an example of the extraction of records having the equivalence relation;

FIG. 4C is a diagram of an example of the extraction of records having the list relation;

FIG. 4D is a diagram of an example of the extraction of the number of types of pieces of attribute data for each attribute of records having the hierarchy relation;

FIG. 5 is a diagram of an example of a determination result screen;

FIG. 6A is a flowchart of an example of a procedure of relation estimation processing;

FIG. 6B is a flowchart of an example of a procedure of set relation extraction processing;

FIG. 6C is a flowchart of an example of a procedure of list relation extraction processing;

FIG. 6D is a flowchart of an example of a procedure of counterexample extraction processing;

FIG. 6E is a flowchart of an example of a procedure of number-of-types extraction processing;

FIG. 6F is a flowchart of an example of a procedure of output processing; and

FIG. 7 is a diagram of an example of a computer that executes a relation estimation program.

### DESCRIPTION OF EMBODIMENTS

Although the conventional technologies specify with which meaning a used word has been used, they are unable to estimate the inter-attribute semantic relation.

Preferred embodiments of the present invention will be explained with reference to accompanying drawings. This invention is not limited by the embodiments. The embodiments can be combined with each other as appropriate to the extent that processing details are not contradictory.

### [a] First Embodiment

### Apparatus Configuration

The following describes an information processing apparatus 10 according to the present embodiment. The information processing apparatus 10 is an apparatus that supports the estimation of an inter-attribute semantic structure of data in which respective attributes and pieces of attribute data related to the respective attributes are stored in association with each other. The information processing apparatus 10 is a computer such as a personal computer or a server computer, for example. The information processing apparatus 10 may be installed in one computer or can also be installed in a cloud system including a plurality of computers. In the present embodiment, a case in which the information processing apparatus 10 is one computer will be described as an example. The information processing apparatus 10 may be a portable terminal apparatus such as a smartphone or a tablet terminal.

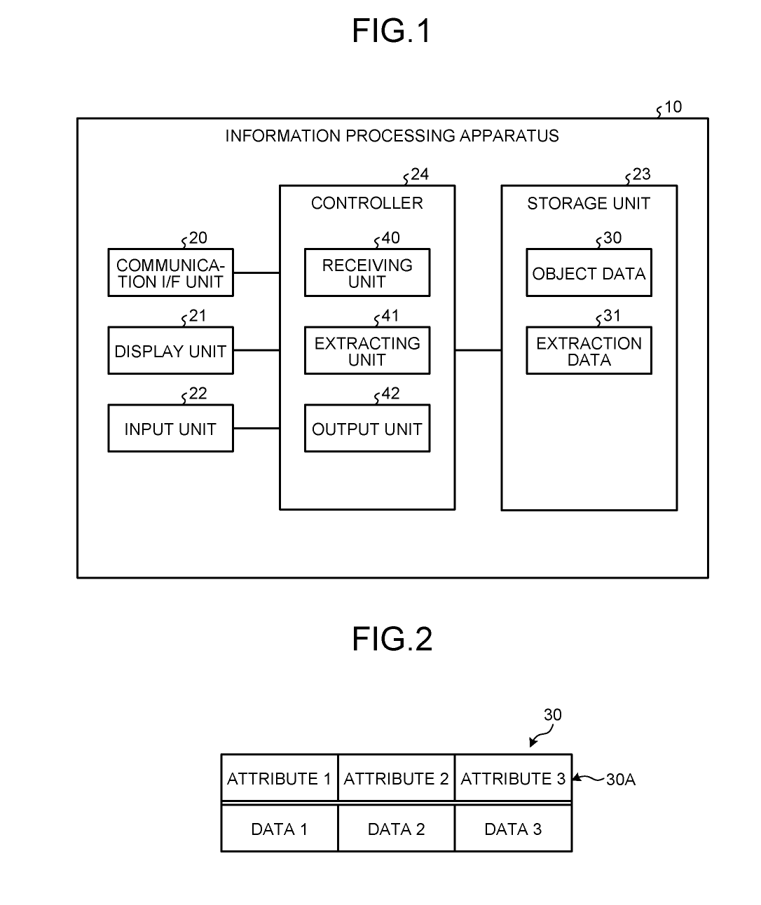

FIG. 1 is a diagram of a functional configuration of an information processing apparatus. As illustrated in FIG. 1, the information processing apparatus 10 includes a communication interface (I/F) unit 20, a display unit 21, an input unit 22, a storage unit 23, and a controller 24. The information processing apparatus 10 may include other devices apart from the above devices.

The communication I/F unit 20 is an interface for performing communication control with another apparatus. Examples of the communication I/F unit 20 include a network interface card such as a LAN card.

The communication I/F unit 20 transmits and receives various kinds of information with the other apparatus via a network (not illustrated). The communication I/F unit 20 receives object data as an object of semantic relation estimation from the other apparatus, for example.

The display unit 21 is a display device that displays various kinds of information. Examples of the display unit 21 include display devices such as a liquid crystal display (LCD). The display unit 21 displays various kinds of information. The display unit 21 displays various kinds of screens such as various kinds of operating screens, for example.

The input unit 22 is an input device that receives input of various kinds of information. Examples of the input unit 22 include input devices that receive input of operations of a mouse, a keyboard, or the like, various kinds of buttons provided in the information processing apparatus 10, and input devices such as a transmission type touch sensor provided on the display unit 21. The input unit 22 receives input of various kinds of information. The input unit 22 receives various kinds of operation input, for example. The input unit 22 receives operation input from a user and inputs operation information indicating the received operation details to the controller 24. Although the display unit 21 and the input unit 22 are separated from each other in the example in FIG. 1 because the functional configuration is illustrated, a device in which the display unit 21 and the input unit 22 are integrally provided may be configured, for example.

The storage unit 23 is a storage device that stores therein various kinds of data. The storage unit 23 is a storage apparatus such as a hard disk, a solid state drive (SSD), or an optical disc, for example. The storage unit 23 may also be a data-rewritable semiconductor memory such as a random access memory (RAM), a flash memory, or a nonvolatile static random access memory (NVSRAM).

The storage unit 23 stores therein an operating system (OS) and various kinds of computer programs executed by the controller 24. The storage unit 23 stores therein various kinds of computer programs including computer programs that execute various kinds of processing described below, for example. Furthermore, the storage unit 23 stores therein various kinds of data used in the computer programs executed by the controller 24. The storage unit 23 stores therein object data 30 and extraction data 31, for example.

The object data 30 is data of an object for which an inter-attribute semantic relation is estimated. The object data 30 stores therein respective attributes and pieces of attribute data related to the respective attributes in association with each other about a plurality of events. The event is a state in which each attribute data is obtained from the object or a state in which each attribute data is associated with the object, for example. There are various data formats that can store therein respective attributes and the pieces of attribute data related to the respective attributes in association with each other in this way. In tabular format data, respective attributes are arranged as respective columns, records are separated by each event, and pieces of attribute data related to the respective attributes of the event are stored in column areas corresponding to the respective attributes, for example. In comma separated values (CSV) format data, an order of respective attributes is determined, records are separated by each event, and pieces of attribute data related to the respective attributes of the event are stored separated by commas in an order of the order of the respective attributes, for example.

FIG. 2 is a diagram of an example of a data configuration of object data. The example in FIG. 2 illustrates an example of a case in which the object data 30 is data in a tabular format. The object data 30 provides a header 30A. Attributes provide attribute names as identification information that identifies the respective attributes. These attribute names may be names representing the attributes. The attribute names may be names provided for identifying the attributes such as “Attribute 1”, “Attribute 2”, and “Attribute 3”. The header 30A provides an area storing the attribute names of the attributes. The header 30A provides “Attribute 1”, “Attribute 2”, and “Attribute 3” as the attribute names. The object data 30 arranges the respective attributes as respective columns, separates the records by each event, and stores therein pieces of attribute data related to the respective attributes in column areas corresponding to the respective attributes of the event. In the example in FIG. 2, “Data 1” is stored as the attribute data of the attribute name “Attribute 1”, “Data 2” is stored as the attribute data of the attribute name “Attribute 2”, and “Data 3” is stored as the attribute data of the attribute name “Attribute 3”.

The data in which respective attributes and pieces of attribute data related to the respective attributes are stored in association with each other in this way is not clear in an inter-attribute semantic relation.

The following describes the inter-attribute semantic relation. When pieces of attribute data are stored for each attribute, the respective pieces of attribute data may have various relations. Examples of such relations of the respective pieces of attribute data include set, equivalence, hierarchy, and list. The following describes examples of the relations of the respective pieces of attribute data.

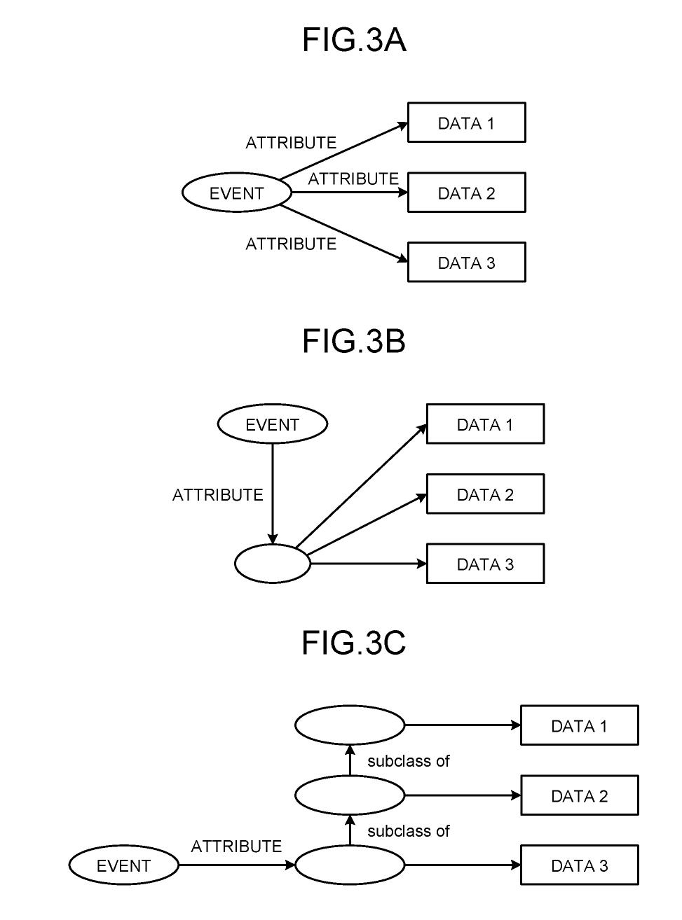

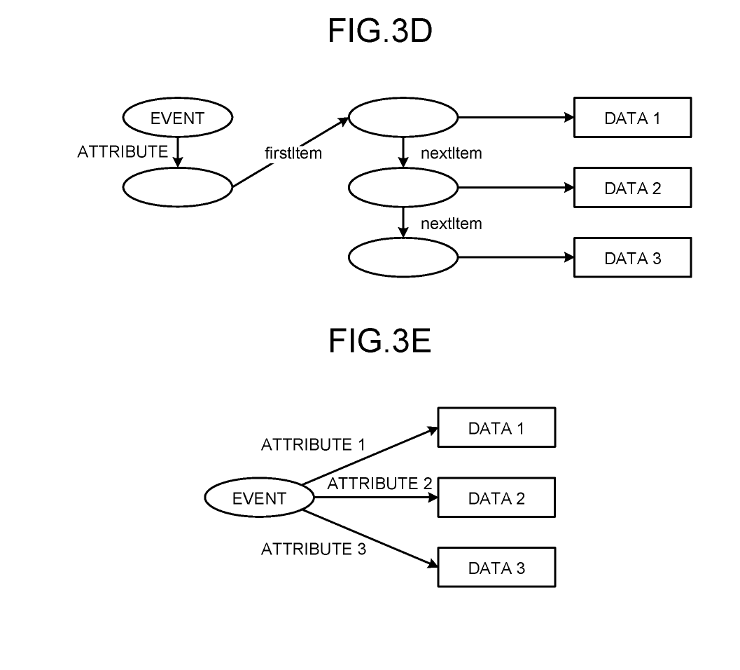

FIG. 3A is a diagram of an example of a set relation. When there are a plurality of pieces of attribute data of the same attribute about the event and when there is no priority among the pieces of attribute data, the pieces of attribute data have the set relation. The pieces of attribute data having this set relation represent different objects. Examples of such an attribute include a keyword. When there are Data 1, Data 2, and Data 3 as keywords related to the event, Data 1, Data 2, and Data 3 have the set relation.

FIG. 3B is a diagram of an example of an equivalence relation. When there are a plurality of representations, although the attribute of the event is single, pieces of attribute data have the equivalence relation. The pieces of attribute data having this equivalence relation represent the same object. Examples of such an attribute include a company name. Although the formal name of a company is “Fujitsu Kabushiki Kaisha”, it may be written as “Fujitsu” or “Fujitsu (kabu)” as abbreviates, for example. These “Fujitsu” and “Fujitsu (kabu)” both represent “Fujitsu Kabushiki Kaisha”.

FIG. 3C is a diagram of an example of a hierarchy relation. The event may determine a plurality of attributes hierarchically such as a tree structure, for example. When the attributes store therein pieces of attribute data of the respective hierarchies, the pieces of attribute data of the attributes have the hierarchy relation. When the attributes store therein the pieces of attribute data of the respective hierarchies in this way, the attribute data of a higher hierarchy is determined by the attribute data of a lower hierarchy. About the event, classifications are hierarchically determined as attributes including a large classification that is broadly classified, a medium classification obtained by classifying respective large classifications, and a small classification obtained by classifying respective medium classifications in detail, for example. In this case, the medium classification is included in any large classification. The small classification is included in any medium classification. Consequently, when the small classification is determined, the medium classification and the large classification are determined from a hierarchical structure. FIG. 3C illustrates that the attributes are hierarchical in which Data 2 is the subclass of Data 1, and Data 3 is the subclass of Data 2. In the example in FIG. 3C, when Data 3 is determined about the event, Data 2 and Data 1 are determined from the hierarchy relation. In this case, Data 1, Data 2, and Data 3 have the hierarchy relation.

FIG. 3D is a diagram of an example of a list relation. When there are a plurality of pieces of attribute data and there is a meaning in an order of the pieces of attribute data, although the attribute of the event is single, for example, the pieces of attribute data have the list relation. Examples of such an attribute include author names of a paper. FIG. 3D illustrates that as the attribute of the event the attribute data of the first element is associated with the top and the pieces of attribute data of the respective elements are associated with the next pieces of attribute data. In this case, Data 1, Data 2, and Data 3 have the list relation.

For reference, the following describes an irrelevant state in which there is no relation among attributes. FIG. 3E is a diagram of an example of the irrelevant state. When there are a plurality of attributes about the event and when the attribute data of each attribute changes independently without influenced by another attribute data, the respective attributes are in the irrelevant state. In the example in FIG. 3E, there are Data 1 of Attribute 1, Data 2 off Attribute 2, and Data 3 of Attribute 3 about the event. When Data 1, Data 2, and Data 3 change independently without influenced by the others, Data 1, Data 2, and Data 3 have the irrelevant state.

Referring back to FIG. 1, the extraction data 31 is data that stores therein data extracted by an extracting unit 41 described below.

The controller 24 is a device that controls the information processing apparatus 10. Examples of the controller 24 to be employed include electronic circuits such as a central processing unit (CPU) and a micro processing unit (MPU) and integrated circuits such as an application specific integrated circuit (ASIC) and a field programmable gate array (FPGA). The controller 24 has an internal memory for storing therein computer programs that provide various kinds of processing procedures and control data and executes various kinds of processing by these. The various kinds of computer programs operate, thereby causing the controller 24 to function as various kinds of processing units. The controller 24 includes a receiving unit 40, the extracting unit 41, and an output unit 42, for example.

The receiving unit 40 performs various kinds of reception. The receiving unit 40 receives various kinds of operation instructions, for example. The receiving unit 40 causes the display unit 21 to display various kinds of screens such as an operating screen and receives operation instructions such as an instruction to start the estimation of an inter-attribute relation from the input unit 22, for example.

The extracting unit 41 performs various kinds of extraction. The extracting unit 41 extracts data of records about which a matching relation of pieces of attribute data among records satisfies a certain condition from the object data 30, for example. The extracting unit 41 extracts data of records having the set, equivalence, hierarchy, and list relations from a matching relation of pieces of attribute data among records of the object data 30 or an order of the attributes in which the pieces of attribute data thereof match, for example. The extracting unit 41 stores the extracted data of the records in the extraction data 31 for each attribute relation.

The extracting unit 41 successively selects two records for which the pieces of attribute data are compared with each other from the object data 30, for example. The extracting unit 41 successively selects a first record and a second record from the object data 30, for example. The extracting unit 41 compares the pieces of attribute data between the first record and the second record and determines whether the set relation is present between the attributes. The extracting unit 41 extracts records having the set relation between the attributes. The extracting unit 41 determines whether the attribute data of a first attribute of the first record matches the attribute data of a second attribute different from the first attribute of the second record and whether the attribute data of the second attribute of the first record does not match the first attribute of the second record, for example. If the attribute data of the first attribute of the first record matches the attribute data of the second attribute of the second record and the attribute data of the second attribute of the first record does not match the first attribute of the second record, the extracting unit 41 extracts the first record and the second record.

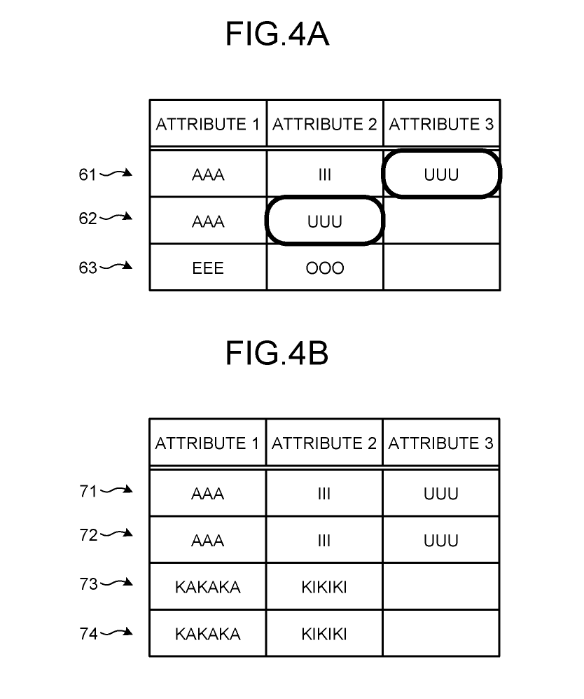

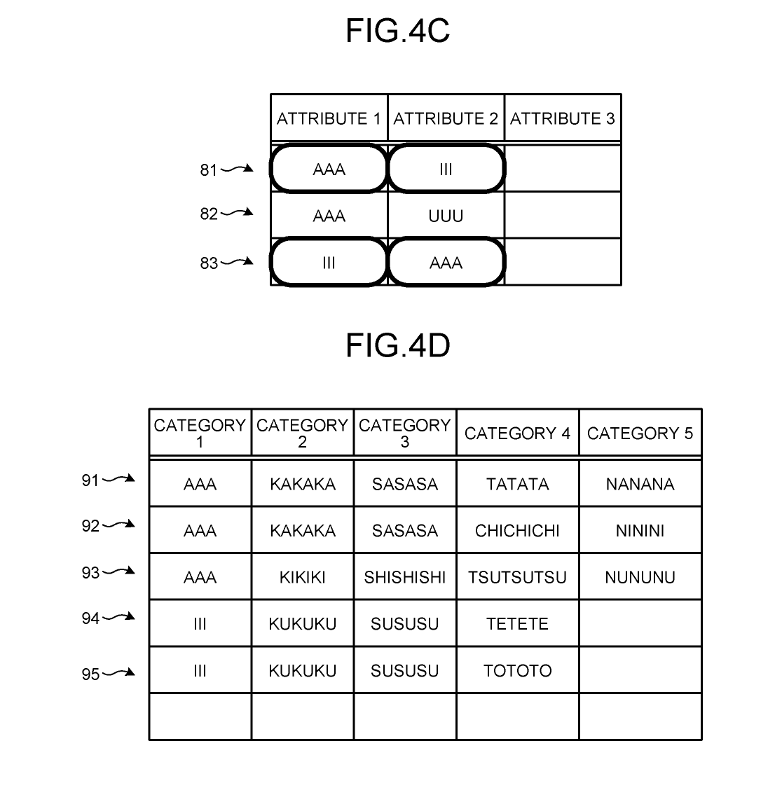

FIG. 4A is a diagram of an example of the extraction of records having the set relation. The object data 30 illustrated in FIG. 4A stores therein three records 61, 62, and 63. In the record 61, the attribute data of the attribute name “Attribute 1” is “AAA”, the attribute data of the attribute name “Attribute 2” is “III”, and the attribute data of the attribute name “Attribute 3” is “UUU”. In the record 62, the attribute data of the attribute name “Attribute 1” is “AAA”, the attribute data of the attribute name “Attribute 2” is “UUU”, and the attribute data of the attribute name “Attribute 3” is null. In the record 63, the attribute data of the attribute name “Attribute 1” is “EEE”, the attribute data of the attribute name “Attribute 2” is “000”, and the attribute data of the attribute name “Attribute 3” is null. In the example in FIG. 4A, the attribute data “UUU” of the attribute name “Attribute 3” of the record 61 matches the attribute data “UUU” of the attribute name “Attribute 2” of the record 62. In addition, in the attribute name “Attribute 3” of the record 62, the attribute data is null, which does not match the attribute data “III” of the attribute name “Attribute 2” of the record 61. These records 61 and 62 have the set relation in the attribute names “Attribute 2” and “Attribute 3”. The extracting unit 41 stores the records 61 and 62 in the extraction data 31 as the data of the records having the set relation.

The extracting unit 41 compares the pieces of attribute data between the first record and the second record and determines whether the equivalence relation is present between the attributes. The extracting unit 41 extracts records having the equivalence relation between the attributes. The extracting unit 41 determines whether all the pieces of attribute data are the same in the respective attributes other than an attribute data of null between the first record and the second record, for example. If all the pieces of attribute data of the respective attributes are the same between the first record and the second record, the extracting unit 41 extracts the first record and the second record.

FIG. 4B is a diagram of an example of the extraction of records having the equivalence relation. The object data 30 illustrated in FIG. 4B stores therein four records 71, 72, 73, and 74. In the record 71, the attribute data of the attribute name “Attribute 1” is “AAA”, the attribute data of the attribute name “Attribute 2” is “III”, and the attribute data of the attribute name “Attribute 3” is “UUU”. In the record 72, the attribute data of the attribute name “Attribute 1” is “AAA”, the attribute data of the attribute name “Attribute 2” is “III”, and the attribute data of the attribute name “Attribute 3” is “UUU”. In the record 73, the attribute data of the attribute name “Attribute 1” is “KAKAKA”, the attribute data of the attribute name “Attribute 2” is “KIKIKI”, and the attribute data of the attribute name “Attribute 3” is null. In the record 74, the attribute data of the attribute name “Attribute 1” is “KAKAKA”, the attribute data of the attribute name “Attribute 2” is “KIKIKI”, and the attribute data of the attribute name “Attribute 3” is null. In the example in FIG. 4B, the record 71 and the record 72 match in the attribute data among the attributes with the attribute names “Attribute 1”, “Attribute 2”, and “Attribute 3” and have the equivalence relation. The record 73 and the record 74 match in the attribute data between the attributes with the attribute names “Attribute 1” and “Attribute 2” and have the equivalence relation. The extracting unit 41 stores the records 71 and 72 and the records 73 and 74 in the extraction data 31 as the data of the records having the equivalence relation.

When the pieces of data stored in the object data 30 are pieces of data having the equivalence relation, all the pieces of data are extracted.

In view of this situation, the information processing apparatus 10 according to the present embodiment extracts counterexample records that do not have the equivalence relation from the object data 30. With this processing, in the object data 30, no record is extracted when the equivalence relation is present between the attributes of the respective records. Consequently, the object data 30 can be determined that the pieces of stored data have the equivalence relation by the fact that no record is extracted.

Given this situation, the extracting unit 41 according to the present embodiment extracts the counterexample records that do not have the equivalence relation in place of the extraction of the records having the equivalence relation between the attributes. The extracting unit 41 determines whether part of the pieces of attribute data of the respective attributes matches and the other part of the pieces of attribute data of the respective attributes does not match between the first record and the second record, for example. If part of the pieces of attribute data of the respective attributes matches and the other part of the pieces of attribute data of the respective attributes does not match between the first record and the second record, the extracting unit 41 extracts the first record and the second record. In the example in FIG. 4B, no pieces of attribute data match only in partial attributes between the records, no counterexample records are extracted.

The extracting unit 41 compares the pieces of attribute data between the first record and the second record and determines whether the list relation is present between the attributes. The extracting unit 41 extracts records having the list relation between the attributes. The extracting unit 41 determines whether the pieces of attribute data are exchanged in two or more attributes between the first record and the second record, for example. If the pieces of attribute data are exchanged in two or more attributes, the extracting unit 41 extracts the first record and the second record.

FIG. 4C is a diagram of an example of the extraction of records having the list relation. The object data 30 illustrated in FIG. 4C stores therein three records 81, 82, and 83. In the record 81, the attribute data of the attribute name “Attribute 1” is “AAA”, the attribute data of the attribute name “Attribute 2” is “III”, and the attribute data of the attribute name “Attribute 3” is null In the record 82, the attribute data of the attribute name “Attribute 1” is “AAA”, the attribute data of the attribute name “Attribute 2” is “UUU”, and the attribute data of the attribute name “Attribute 3” is null. In the record 83, the attribute data of the attribute name “Attribute 1” is “III”, the attribute data of the attribute name “Attribute 2” is “AAA”, and the attribute data of the attribute name “Attribute 3” is null. In the example in FIG. 4C, the record 81 and the record 83 have exchanged pieces of attribute data in the attributes with the attribute names “Attribute 1” and “Attribute 2” and have the list relation. The extracting unit 41 stores the records 81 and 83 in the extraction data 31 as the data of the records having the list relation.

The extracting unit 41 compares the pieces of attribute data among the respective records of the object data 30 and extracts information for use in determination whether the hierarchy relation is present between the attributes. The extracting unit 41 extracts, for the respective records of the object data 30, the number of types of the pieces of attribute data stored in the respective records of the object data 30 for each attribute with the same attribute data classified into one type, for example.

FIG. 4D is a diagram of an example of the extraction of the number of types of pieces of attribute data for each attribute of records having the hierarchy relation. The object data 30 illustrated in FIG. 4D provides respective attributes with the attribute names “Category 1”, “Category 2”, “Category 3”, “Category 4”, and “Category 5” and stores therein five records of records 91 to 95. In the record 91, the attribute data of the attribute name “Category 1” is “AAA”, the attribute data of the attribute name “Category 2” is “KAKAKA”, the attribute data of the attribute name “Category 3” is “SASASA”, the attribute data of the attribute name “Category 4” is “TATATA”, and the attribute data of the attribute name “Category 5” is “NANANA”. In the record 92, the attribute data of the attribute name “Category 1” is “AAA”, the attribute data of the attribute name “Category 2” is “KAKAKA”, the attribute data of the attribute name “Category 3” is “SASASA”, the attribute data of the attribute name “Category 4” is “CHICHICHI”, and the attribute data of the attribute name “Category 5” is “NININI”. In the record 93, the attribute data of the attribute name “Category 1” is “AAA”, the attribute data of the attribute name “Category 2” is “KIKIKI”, the attribute data of the attribute name “Category 3” is “SHISHISHI”, the attribute data of the attribute name “Category 4” is “TSUTSUTSU”, and the attribute data of the attribute name “Category 5” is “NUNUNU”. In the record 94, the attribute data of the attribute name “Category 1” is “III”, the attribute data of the attribute name “Category 2” is “KUKUKU”, the attribute data of the attribute name “Category 3” is “SUSUSU”, the attribute data of the attribute name “Category 4” is “TETETE”, and the attribute data of the attribute name “Category 5” is null. In the record 95, the attribute data of the attribute name “Category 1” is “III”, the attribute data of the attribute name “Category 2” is “KUKUKU”, the attribute data of the attribute name “Category 3” is “SUSUSU”, the attribute data of the attribute name “Category 4” is “TOTOTO”, and the attribute data of the attribute name “Category 5” is null.

When the hierarchy relation is present among the pieces of attribute data in an order of arrangement of the attributes in the object data 30, the number of types of the pieces of attribute data of the respective attributes is not less than the number of types of the pieces of attribute data of the respective preceding attributes in the order of arrangement of the object data 30. In other words, when the hierarchy relation is present among the pieces of attribute data in the order of arrangement of the attributes in the object data 30, the number of types of the pieces of attribute data of the respective attributes does not decrease in the number of types of the pieces of attribute data from the respective preceding attributes in the order of arrangement of the object data 30. In the records 91 to 93, for example, the number of types of the pieces of attribute data of the attribute with the attribute name “Category 1” is one. The number of types of the pieces of attribute data of the attribute with the attribute name “Category 2” is two. The number of types of the pieces of attribute data of the attribute with the attribute name “Category 3” is two. The number of types of the pieces of attribute data of the attribute with the attribute name “Category 4” is three. The number of types of the pieces of attribute data of the attribute with the attribute name “Category 5” is three. Consequently, when the hierarchy relation is present among the pieces of attribute data in the order of arrangement of the attributes in the object data 30, the number of types of the pieces of attribute data of the respective attributes is monotonous nondecreasing in the order of arrangement of the attributes in the object data 30.

When null is permitted as the pieces of attribute data of the attributes having the hierarchy relation, the number of types of the pieces of attribute data of the respective attributes may decrease from the number of types of the respective preceding attributes in the order of arrangement of the object data 30. In the records 91 to 95, for example, the number of types of the pieces of attribute data of the attribute with the attribute name “Category 4” is five, whereas the number of types of the pieces of attribute data of the attribute with the attribute name “Category 5” is three.

Given this situation, when null is permitted as the pieces of attribute data of the attributes having the hierarchy relation, the extracting unit 41 counts the number of types of the pieces of attribute data of the attributes as follows. First, the extracting unit 41 adds an attribute as an object range from which the number of types of the pieces of attribute data is extracted one by one in the order of arrangement in the object data 30. The extracting unit 41 then extracts the number of types of the pieces of stored attribute data of the respective records of the object data 30 for each attribute included in the object range except a record in which no attribute data is stored in any of the attributes of the object range for each object range.

The following describes a procedure of extracting the number of types of the pieces of attribute data in the example in FIG. 4D. First, the extracting unit 41 sets the attributes of the attribute names “Category 1” and “Category 2” to the object range. The extracting unit 41 then extracts the number of types of the pieces of attribute data for each attribute with the attribute names “Category 1” and “Category 2” except a record in which no attribute data is stored in the attributes with the attribute names “Category 1” and “Category 2”. In the example in FIG. 4D, there is no record in which no attribute data is stored in the attributes with the attribute names “Category 1” and “Category 2”. Consequently, the number of types of the pieces of attribute data of the attribute with the attribute name “Category 1” is determined to be two. The number of types of the pieces of attribute data of the attribute with the attribute name “Category 2” is determined to be three.

Next, the extracting unit 41 sets the attributes with the attribute names “Category 1” to “Category 3” to the object range. The extracting unit 41 then extracts the number of types of the pieces of attribute data for each attribute with the attribute names “Category 1” to “Category 3” except a record in which no attribute data is stored in the attributes with the attribute names “Category 1” to “Category 3”. In the example in FIG. 4D, there is no record in which no attribute data is stored in the attributes with the attribute names “Category 1” to “Category 3”. Consequently, the number of types of the pieces of attribute data of the attribute with the attribute name “Category 1” is determined to be two. The number of types of the pieces of attribute data of the attribute with the attribute name “Category 2” is determined to be three. The number of types of the pieces of attribute data of the attribute with the attribute name “Category 3” is determined to be three.

Next, the extracting unit 41 sets the attributes with the attribute names “Category 1” to “Category 4” to the object range. The extracting unit 41 then extracts the number of types of the pieces of attribute data for each attribute with the attribute names “Category 1” to “Category 4” except a record in which no attribute data is stored in the attributes with the attribute names “Category 1” to “Category 4”. In the example in FIG. 4D, there is no record in which no attribute data is stored in the attributes with the attribute names “Category 1” to “Category 4”. Consequently, the number of types of the pieces of attribute data of the attribute with the attribute name “Category 1” is determined to be two. The number of types of the pieces of attribute data of the attribute with the attribute name “Category 2” is determined to be three. The number of types of the pieces of attribute data of the attribute with the attribute name “Category 3” is determined to be three. The number of types of the pieces of attribute data of the attribute with the attribute name “Category 4” is determined to be five.

Next, the extracting unit 41 sets the attributes with the attribute names “Category 1” to “Category 5” to the object range. The extracting unit 41 then extracts the number of types of the pieces of attribute data for each attribute with the attribute names “Category 1” to “Category 5” except a record in which no attribute data is stored in the attributes with the attribute names “Category 1” to “Category 5”. In the example in FIG. 4D, in the records 94 and 95, no attribute data is stored in the attribute with the attribute name “Category 5”, and the number of types of the pieces of attribute data is determined from the records 91 to 93. In this case, the number of types of the pieces of attribute data of the attribute with the attribute name “Category 1” is determined to be one. The number of types of the pieces of attribute data of the attribute with the attribute name “Category 2” is determined to be two. The number of types of the pieces of attribute data of the attribute with the attribute name “Category 3” is determined to be two. The number of types of the pieces of attribute data of the attribute with the attribute name “Category 4” is determined to be three. The number of types of the pieces of attribute data of the attribute with the attribute name “Category 5” is determined to be three.

As described above, the extracting unit 41 extracts the data of the records having the set, equivalence, hierarchy, and list relations from the matching relation of the pieces of attribute data among the records from the object data 30. The set, equivalence, hierarchy, and list records may be extracted separately from the object data 30. When a record having various kinds of semantic relations among the attributes is mixed in the object data 30, the set, equivalence, hierarchy, and list records are extracted from the object data 30. One record may be extracted in a plurality of semantic relations.

The output unit 42 performs various kinds of output. The output unit 42 outputs a determination result of the inter-attribute semantic relation based on an extraction result by the extracting unit 41, for example. The output unit 42 causes the display unit 21 to display a determination result screen and displays the determination result of the inter-attribute semantic relation. If the records having the set relation between attributes are extracted by the extracting unit 41, the output unit 42 outputs a determination result indicating that a set semantic relation is present between the attributes, for example. If the records having the list relation between attributes are extracted by the extracting unit 41, the output unit 42 outputs a determination result indicating that a list semantic relation is present between the attributes. If the number of types of pieces of attribute data for each attribute is monotonous nondecreasing in the order of arrangement of the attributes in any object range extracted by the extracting unit 41, the output unit 42 outputs a determination result indicating that a hierarchy semantic relation is present between the attributes. If the records having the equivalence relation between attributes are extracted by the extracting unit 41, the output unit 42 outputs a determination result indicating that an equivalence semantic relation is present between the attributes. In the present embodiment, the extracting unit 41 extracts the counterexample records that do not have the equivalence relation. Consequently, in the present embodiment, if the counterexample records are not extracted by the extracting unit 41, the output unit 42 outputs the determination result indicating that the equivalence semantic relation is present between the attributes.

The output unit 42 outputs the data of the records extracted by the extracting unit 41 as grounds for determination.

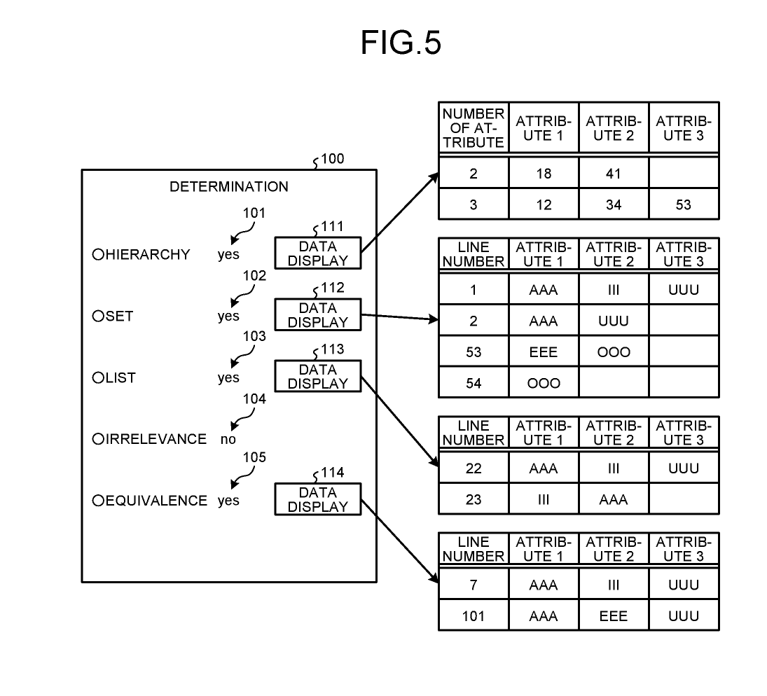

FIG. 5 is a diagram of an example of the determination result screen. This determination result screen 100 includes display areas 101 to 105 that display determination results of the inter-attribute semantic structure.

The display area 101 is an area that displays a determination result whether the hierarchy relation is present between the attributes of the object data 30. The output unit 42 causes the display area 101 to display “yes” if the records having the hierarchy relation between the attributes are extracted by the extracting unit 41, and causes the display area 101 to display no if the records having the hierarchy relation are not extracted.

The display area 102 is an area that displays a determination result whether the set relation is present between the attributes of the object data 30. The output unit 42 causes the display area 102 to display “yes” if the records having the set relation between the attributes are extracted by the extracting unit 41, and causes the display area 102 to display no if the records having the set relation are not extracted.

The display area 103 is an area that displays a determination result whether the list relation is present between the attributes of the object data 30. The output unit 42 causes the display area 103 to display “yes” if the records having the list relation are extracted by the extracting unit 41, and causes the display area 103 to display no if the records having the list relation are not extracted.

The display area 105 is an area that displays a determination result whether the equivalence relation is present between the attributes of the object data 30. The output unit 42 causes the display area 105 to display “yes” if the records having the equivalence relation are extracted by the extracting unit 41, and causes the display area 105 to display no if the records having the equivalence relation are not extracted. In the present embodiment, the extracting unit 41 extracts the counterexample records that do not have the equivalence relation. Consequently, in the present embodiment, the output unit 42 causes the display area 105 to display “yes” if the counterexample records are not extracted by the extracting unit 41, and causes the display area 105 to display no if the counterexample records are extracted.

The display area 104 is an area that displays a determination result whether the attributes of the object data 30 are irrelevant. The output unit 42 causes the display area 104 to display “yes” if no relation data about any of hierarchy, set, list, and equivalence is extracted, and causes the display area 104 to display no if any relation data is extracted.

The determination result screen 100 includes buttons 111 to 114 that instruct to display data as grounds for the determination of the inter-attribute semantic structure.

If the button 111 is selected, the output unit 42 outputs the number of types of the pieces of attribute data for each attribute for each object range. In the example in FIG. 5, when the two attributes are set to the object range, the number of types of the pieces of attribute data of Attribute 1 is displayed to be 18, and the number of types of the pieces of attribute data of Attribute 2 is displayed to be 41. In the example in FIG. 5, when the three attributes are set to the object range, the number of types of the pieces of attribute data of Attribute 1 is displayed to be 12, the number of types of the pieces of attribute data of Attribute 2 is displayed to be 34, and the number of types of the pieces of attribute data of Attribute 3 is displayed to be 53.

If the button 112 is selected, the output unit 42 outputs the records having the set relation between the attributes extracted by the extracting unit 41. The example in FIG. 5 displays the records having the set relation between the attributes. If the button 113 is selected, the output unit 42 outputs the records having the list relation between the attributes extracted by the extracting unit 41. The example in FIG. 5 displays the records having the list relation between the attributes. If the button 114 is selected, the output unit 42 outputs the records having the equivalence relation between the attributes extracted by the extracting unit 41. In the present embodiment, the extracting unit 41 extracts the counterexample records that do not have the equivalence relation. Consequently, in the present embodiment, if the button 114 is selected, the output unit 42 displays the counterexample records.

The user checks the display areas 101 to 105 of the determination result screen 100 or the data as grounds for the determination of the inter-attribute semantic structure, thereby estimating the inter-attribute semantic relations of the object data 30. The information processing apparatus 10 displays the determination result screen 100 that displays the determination result of the inter-attribute semantic structure, thereby enabling the estimation of the inter-attribute semantic relations by the user.

Procedure of Processing

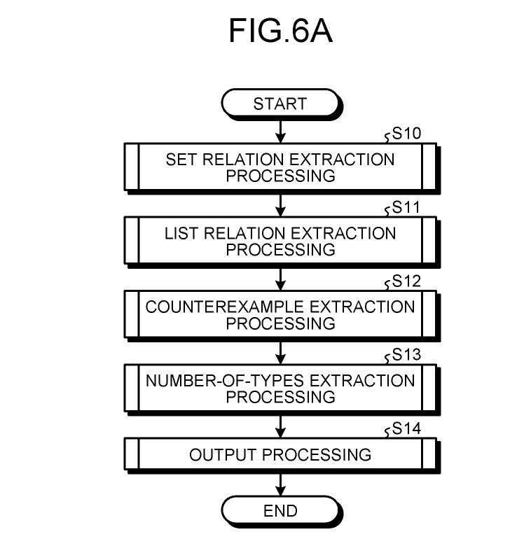

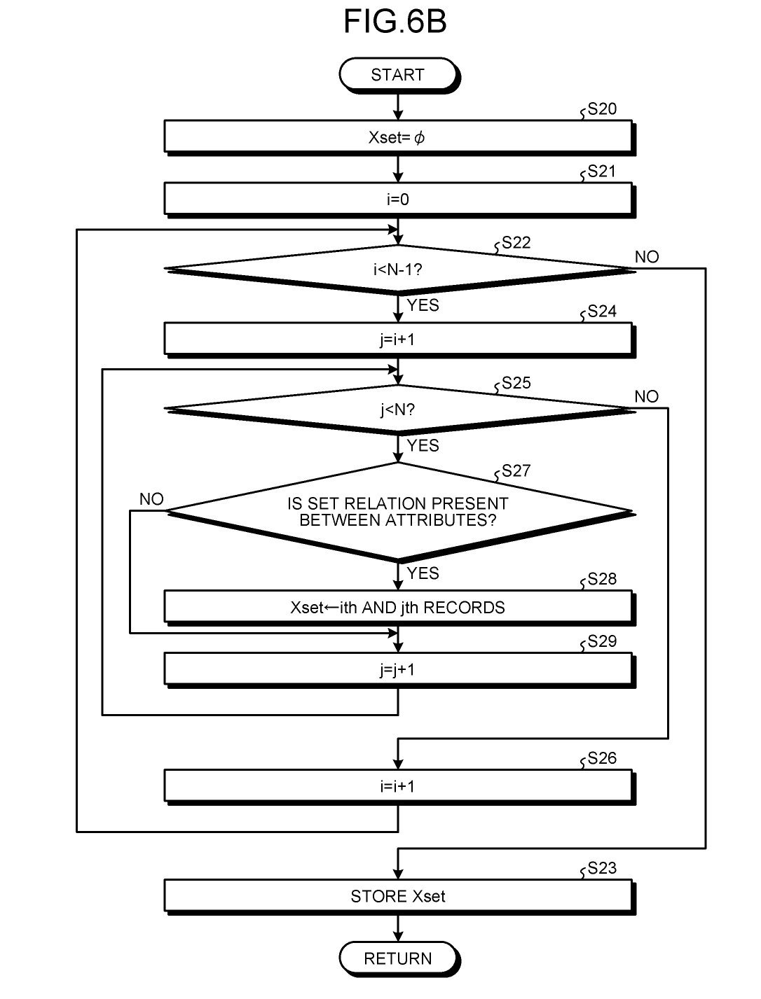

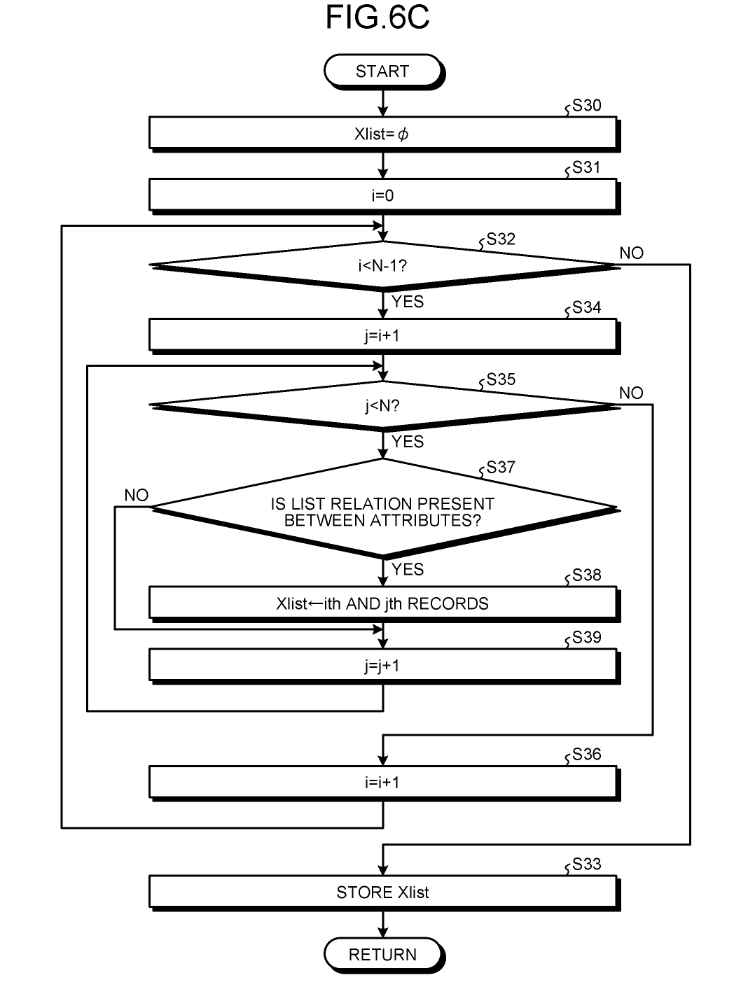

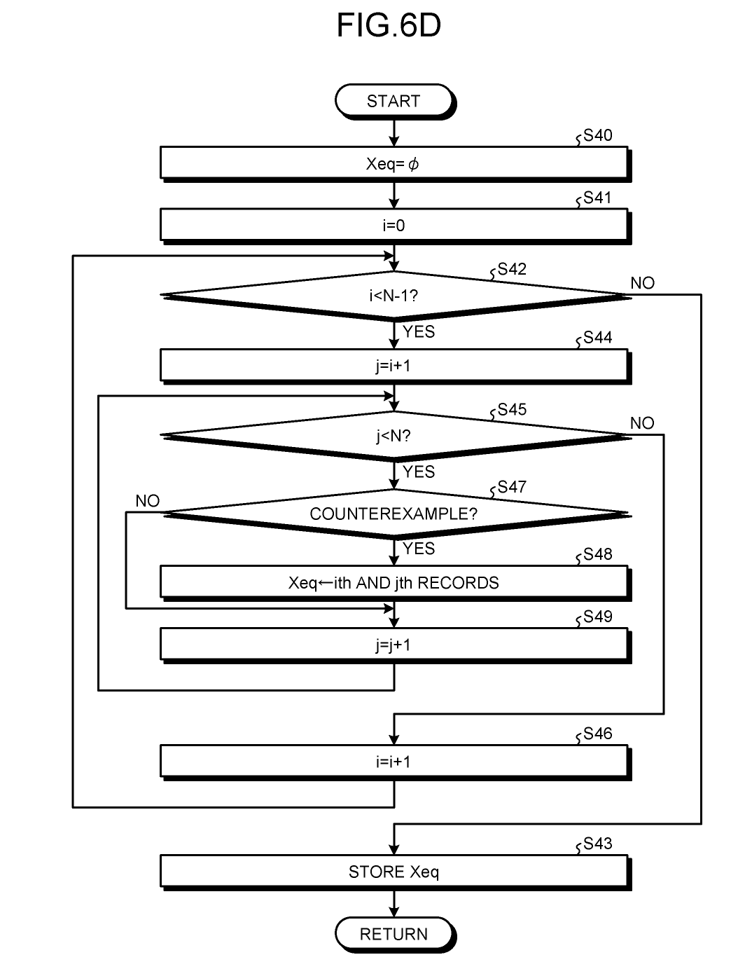

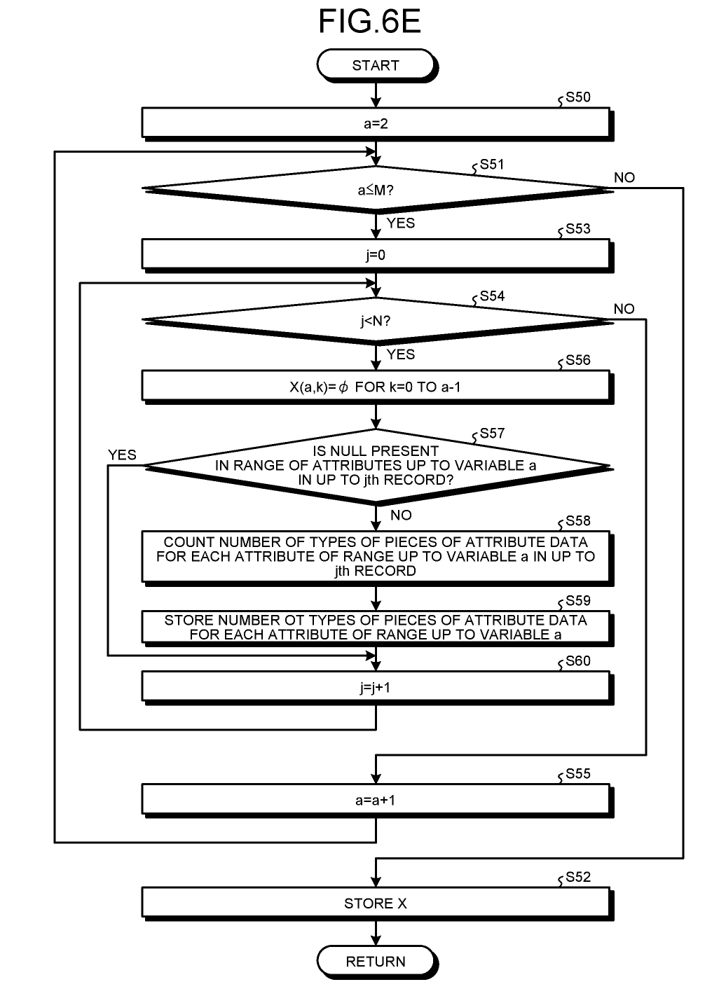

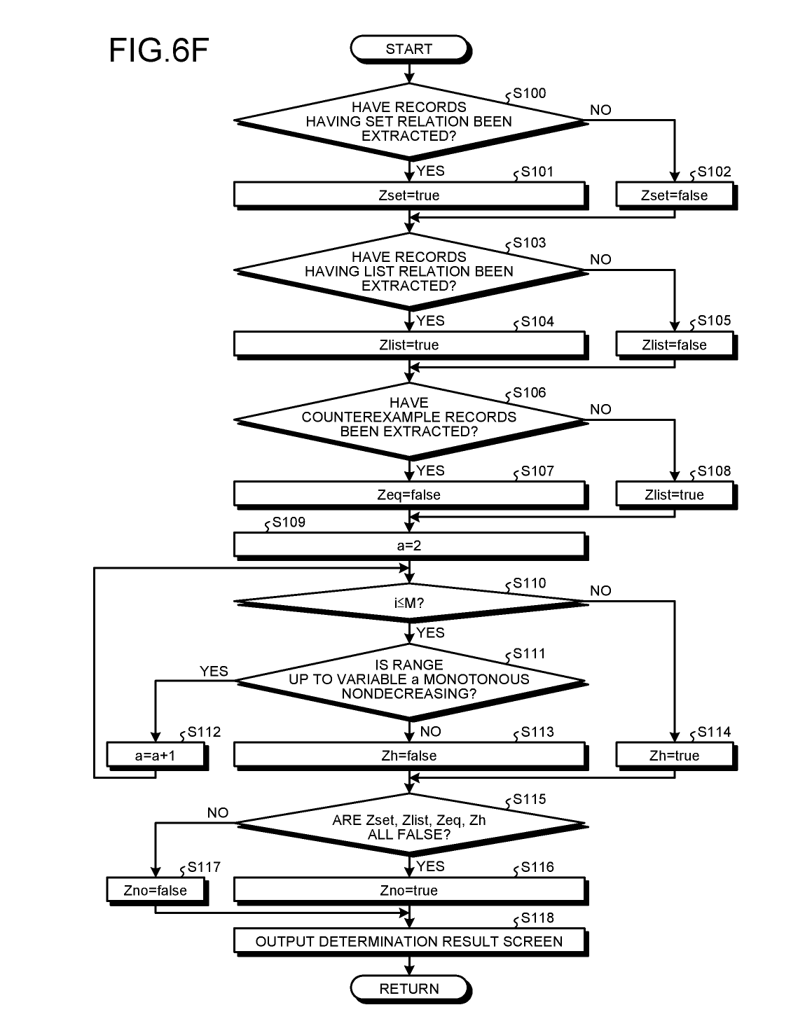

The following describes a procedure of relation estimation processing by which the information processing apparatus 10 according the first embodiment estimates the inter-attribute semantic relations of the object data 30. FIG. 6A is a flowchart of an example of the procedure of the relation estimation processing. This relation estimation processing is executed at certain timing or at timing when an operation of processing to instruct the starting of estimation of semantic relations is received from the input unit 22, for example.

As illustrated in FIG. 6A, the extracting unit 41 executes set relation extraction processing that extracts the records having the set relation between the attributes from the object data 30 (S10). Details of the set relation extraction processing will be described below. Next, the extracting unit 41 executes list relation extraction processing that extracts the records having the list relation between the attributes from the object data 30 (S11). Details of the list relation extraction processing will be described below. Next, the extracting unit 41 executes counterexample extraction processing that extracts the counterexample records that do not have the equivalent relation between the attributes (S12). Details of the counterexample extraction processing will be described below. Next, the extracting unit 41 executes number-of-types extraction processing that extracts the number of types of the piece of attribute data (S13). Details of the number-of-types extraction processing will be described below.

The output unit 42 executes output processing that outputs the determination result of the inter-attribute semantic relation based on an extraction result by the extracting unit 41 (S14) and ends the processing. Details of the output processing will be described below.

Next, the following describes the details of the set relation extraction processing. FIG. 6B is a flowchart of an example of a procedure of the set relation extraction processing. This set relation extraction processing is executed from S10 of the relation estimation processing illustrated in FIG. 6A.

As illustrated in FIG. 6B, the extracting unit 41 initializes an area Xset that stores therein the records having the set relation between the attributes to be null (S20). The extracting unit 41 initializes a variable i to be zero (S21). In the present embodiment, when the number of the records of the object data 30 is N, numbers 0 to N−1 are associated with the respective records. The value of the variable i indicates the number of the first record to be compared.

The extracting unit 41 determines whether the value of the variable i is smaller than N−1 (S22). If the value of the variable i is not smaller than N−1 (No at S22), the extracting unit 41 stores the area Xset in the storage unit 23 (S23), and the process advances to S11 of the relation estimation processing illustrated in FIG. 6A.

In contrast, if the value of the variable i is smaller than N−1 (Yes at S22), the extracting unit 41 sets the value of the variable i+1 in a variable j (S24). The value of this variable j indicates the number of the second record to be compared.

The extracting unit 41 determines whether the value of the variable j is smaller than N (S25). If the value of the variable j is not smaller than N (No at S25), the extracting unit 41 adds the value of the variable i by 1 (S26), and the process advances to the above S22.

In contrast, if the value of the variable j is smaller than N (Yes at S25), the extracting unit 41 compares the pieces of attribute data between the variable ith first record and the variable jth second record and determines whether the set relation is present between the attributes (S27). The extracting unit 41 determines whether the attribute data of the first attribute of the first record matches the attribute data of the second attribute different from the first attribute of the second record and whether the attribute data of the second attribute of the first record does not match the first attribute of the second record, for example. The attribute data of the mth attribute of the ith record is expressed as V(i,m), for example. The attribute data of the nth attribute of the jth record is expressed as V(j,n). The attribute data of the nth attribute of the ith record is expressed as V(i,n). The attribute data of the mth attribute of the jth record is expressed as V(j,m). The extracting unit 41 determines whether m and n that satisfy V(i,m)=V(j,n)≠null, V(i,n)≠V(j,m), and m≠n are present.

If the set relation is present between the attributes (Yes at S27), the extracting unit 41 stores the first record and the second record in association with each other in the area Xset (S28). The extracting unit 41 adds the value of the variable j by 1 (S29), and the process advances to the above S25.

In contrast, if the set relation is absent between the attributes (No at S27), the process advances to the above S29.

Next, the following describes the details of the list relation extraction processing. FIG. 6C is a flowchart of an example of a procedure of the list relation extraction processing. This list relation extraction processing is executed from S11 of the relation estimation processing illustrated in FIG. 6A.

As illustrated in FIG. 6C, the extracting unit 41 initializes an area Xlist that stores therein the records having the list relation between the attributes to be null (S30). The extracting unit 41 initializes the variable i to be zero (S31). The value of this variable i indicates the number of the first record to be compared.

The extracting unit 41 determines whether the value of the variable i is smaller than N−1 (S32). If the value of the variable i is not smaller than N−1 (No at S32), the extracting unit 41 stores the area Xlist in the storage unit 23 (S33), and the process advances to S12 of the relation estimation processing illustrated in FIG. 6A.

In contrast, if the value of the variable i is smaller than N−1 (Yes at S32), the extracting unit 41 sets the value of the variable i+1 in the variable j (S34). The value of this variable j indicates the number of the second record to be compared.

The extracting unit 41 determines whether the value of the variable j is smaller than N (S35). If the value of the variable j is not smaller than N (No at S35), the extracting unit 41 adds the value of the variable i by 1 (S36), and the process advances to the above S32.

In contrast, if the value of the variable j is smaller than N (Yes at S35), the extracting unit 41 compares the pieces of attribute data between the variable ith first record and the variable jth second record and determines whether the list relation is present between the attributes (S37). The extracting unit 41 determines whether the pieces of attribute data are exchanged in two or more attributes between the first record and the second record, for example. The extracting unit 41 determines whether m and n that satisfy V(i,m)=V(j,n)≠null, V(i,n)=V(j,m), and m≠n are present, for example.

If the list relation is present between the attributes (Yes at S37), the extracting unit 41 stores the first record and the second record in association with each other in the area Xlist (S38). The extracting unit 41 adds the value of the variable j by 1 (S39), and the process advances to the above S35.

In contrast, if the list relation is absent between the attributes (No at S37), the process advances to the above S39.

Next, the following describes the details of the counterexample extraction processing. FIG. 6D is a flowchart of an example of a procedure of the counterexample extraction processing. This counterexample extraction processing is executed from S12 of the relation estimation processing illustrated in FIG. 6A.

As illustrated in FIG. 6D, the extracting unit 41 initializes an area Xeq that stores therein the counterexamples that do not have the equivalence relation between the attributes to be null (S40). The extracting unit 41 initializes the variable i to be zero (S41). The value of this variable i indicates the number of the first record to be compared.

The extracting unit 41 determines whether the value of the variable i is smaller than N−1 (S42). If the value of the variable i is not smaller than N−1 (No at S42), the extracting unit 41 stores the area Xeq in the storage unit 23 (S43), and the process advances to S13 of the relation estimation processing illustrated in FIG. 6A.

In contrast, if the value of the variable i is smaller than N−1 (Yes at S42), the extracting unit 41 sets the value of the variable i+1 in the variable j (S44). The value of this variable j indicates the number of the second record to be compared.

The extracting unit 41 determines whether the value of the variable j is smaller than N (S45). If the value of the variable j is not smaller than N (No at S45), the extracting unit 41 adds the value of the variable i by 1 (S46), and the process advances to the above S42.

In contrast, if the value of the variable j is smaller than N (Yes at S45), the extracting unit 41 compares the pieces of attribute data between the variable ith first record and the variable jth second record and determines whether the attributes have a counterexample relation that does not satisfy the equivalence relation (S47). The extracting unit 41 determines whether part of the pieces of attribute data of the respective attributes matches and the other part of the pieces of attribute data of the respective attributes does not match between the first record and the second record, for example. The extracting unit 41 determines whether m and n that satisfy V(i,m)=V(j,m)≠null, V(i,n)≠V(j,n), and m≠n are present, for example.

If the attributes have the counterexample relation (Yes at S47), the extracting unit 41 stores the first record and the second record in association with each other in the area Xeq (S48). The extracting unit 41 adds the value of the variable j by 1 (S49), and the process advances to the above S45.

In contrast, if the attributes do not have the counterexample relation (No at S47), the process advances to the above S49.

Next, the following describes the details of the number-of-types extraction processing. FIG. 6E is a flowchart of an example of a procedure of the number-of-types extraction processing. This number-of-types extraction processing is executed from S13 of the relation estimation processing illustrated in FIG. 6A.

As illustrated in FIG. 6E, the extracting unit 41 initializes a variable a to be 2 (S50). The value of this variable a indicates the number of attributes as the object range. In the present embodiment, the number of all the attributes of the object data 30 is set to M.

The extracting unit 41 determines whether the value of the variable a is M or less (S51). If the value of the variable a is not M or less (No at S51), the extracting unit 41 stores an area X that stores therein the number of types of the pieces of attribute data in the storage unit 23 (S52), and the process advances to S14 of the relation estimation processing illustrated in FIG. 6A.

In contrast, if the value of the variable a is M or less (Yes at S51), the extracting unit 41 initializes the variable j to be zero (S53). The value of this variable j indicates the number of a record as a lower limit of the range in which the number of types of the pieces of attribute data is counted.

The extracting unit 41 determines whether the value of the variable j is smaller than the record number N of the object data 30 (S54). If the value of the variable j is not smaller than N (No at S54), the extracting unit 41 adds the values of the variable a by 1 (S55), and the process advances to the above S51.

In contrast, if the value of the variable j is smaller than N (Yes at S54), the extracting unit 41 initializes an area X(a,k) for k=0 to a−1 to be null (S56). The extracting unit 41 determines whether any piece of null attribute data is present in the attributes of a range up to the variable a in the order of arrangement of the attributes in up to the variable jth record (S57). The attribute data of the lth attribute of the jth record is expressed as V(j,l), for example. The extracting unit 41 determines whether any piece of attribute data that satisfies V(j,l)=null and l<a is present.

If the null attribute data is absent (No at S57), the extracting unit 41 counts the number of types of the pieces of attribute data stored in up to the variable jth record of the object data 30 for the attributes up to the variable a in the order of arrangement of the attributes for each attribute (S58). The extracting unit 41 stores therein the number of types of the pieces of attribute data of the respective attributes in the range up to the variable a (S59). The extracting unit 41 stores the number of types of the pieces of attribute data of the respective attributes with k=0 to a−1 in the range of the attributes up to the variable a in the order of arrangement in the area X(a,k), for example. With this processing, the area X(a,k) stores therein the number of types of the pieces of attribute data in the kth attribute in the order of arrangement in the range of the attributes up to the variable a in the order of arrangement. The extracting unit 41 adds the value of the variable j by 1 (S60), and the process advances to the above S54.

In contrast, if the null attribute data is present (Yes at S57), the process advances to the above S60.

Next, the following describes the details of the output processing. FIG. 6F is a flowchart of an example of a procedure of the output processing. This output processing is executed from S14 of the relation estimation processing illustrated in FIG. 6A.

As illustrated in FIG. 6F, the output unit 42 determines whether the records having the set relation between the attributes have been extracted by the extracting unit 41 (S100). The output unit 42 determines whether the records having the set relation have been extracted based on whether any records are stored in the area Xset, for example. If the records having the set relation have been extracted (Yes at S100), the output unit 42 sets true in a flag Zset indicating the presence or absence of the set relation (S101). In contrast, if the records having the set relation have not been extracted (No at S100), the output unit 42 sets false in the flag Zset (S102).

The output unit 42 determines whether the records having the list relation between the attributes have been extracted by the extracting unit 41 (S103). The output unit 42 determines whether the records having the list relation have been extracted based on whether any records are stored in the area Xlist, for example. If the records having the list relation have been extracted (Yes at S103), the output unit 42 sets true in a flag Zlist indicating the presence or absence of the list relation (S104). In contrast, if the records having the list relation have not been extracted (No at S103), the output unit 42 sets false in the flag Zlist (S105).

The output unit 42 determines whether the counterexample records that do not have the equivalent relation between the attributes have been extracted by the extracting unit 41 (S106). The output unit 42 determines whether the counterexample records have been extracted based on whether any records are stored in the area Xeq, for example. If the counterexample records have been extracted (Yes at S106), the output unit 42 sets false in a flag Zeq indicating the presence or absence of the equivalence relation (S107). In contrast, if the counterexample records have not been extracted (No at S106), the output unit 42 sets true in the flag Zeq (S108). In the present embodiment, the counterexample records that do not have the equivalence relation are extracted, and if the counterexample records are not extracted, it is determined that the equivalence relation is present between the attributes.

The output unit 42 initializes the variable a to be 2 (S109). The value of this variable a indicates the number of attributes as the object range. The output unit 42 determines whether the value of the variable a is M or less (S110). If the value of the variable a is M or less (Yes at S110), the output unit 42 determines whether the number of types of the pieces of attribute data for the attributes up the variable a in the order of arrangement of the attributes extracted by the extracting unit 41 is monotonous nondecreasing for each attribute (S111). The output unit 42 determines whether the number of types of the pieces of attribute data is monotonous nondecreasing based on whether X(a,k)≦X(a,k+1) is satisfied for any k=0 to a−1, for example. If the number of types of the pieces of attribute data is monotonous nondecreasing (Yes at S111), the output unit 42 adds the value of the variable a by 1 (S112), and the process advances to the above S110. In contrast, if the number of types of the pieces of attribute data is not monotonous nondecreasing (No at S111), the hierarchy relation is absent between the attributes, and the output unit 42 sets false in a flag Zh indicating the presence or absence of the hierarchy relation (S113). In contrast, if the value of the variable a is not M or less (No at S110), the number of types of the pieces of attribute data is monotonous nondecreasing in all the object ranges in which the value of the variable a is M, the hierarchy relation is present between the attributes, and the output unit 42 sets true in the flag Zh (S114).

The output unit 42 determines whether the flags Zset, Zlist, Zeq, and Zh are all false (S115). If all of them are false (Yes at S115), the output unit 42 sets true in a flag Zno indicating whether the attributes are irrelevant (S116). In contrast, if not all of them are false (No at S115), the output unit 42 sets false in the flag Zno (S117).

The output unit 42 displays the determination result screen 100 and outputs the determination result of the inter-attribute semantic structure based on the flags Zset, Zlist, Zeq, Zh, and the flag Zno (S118).

Effects

As described above, the information processing apparatus 10 extracts data of events about which a matching relation of pieces of attribute data among respective records satisfies a certain condition from the object data 30. Based on an extraction result, the information processing apparatus 10 outputs a determination result of an inter-attribute semantic relation. With this processing, the information processing apparatus 10 can support the estimation of the inter-attribute semantic relation by a user.

The information processing apparatus 10 extracts records about which pieces of attribute data match among respective records and an order of attributes in which the pieces of attribute data thereof match satisfies a certain condition from the object data 30. With this processing, the information processing apparatus 10 can extract the records having an inter-attribute semantic relation.

The information processing apparatus 10 extracts a first record and a second record about which attribute data of a first attribute of the first record matches attribute data of a second attribute different from the first attribute of the second record and about which attribute data of the second attribute of the first record does not match the first attribute of the second record. The information processing apparatus 10 outputs a determination result indicating that the inter-attribute semantic relation is in the form of set when the records are extracted. With this processing, the information processing apparatus 10 can inform the user of the fact that the set relation is present between the attributes of the object data 30.

The information processing apparatus 10 extracts records about which pieces of attribute data are exchanged in two or more attributes among respective records. The information processing apparatus 10 outputs a determination result indicating that the inter-attribute semantic relation is in the form of list when the records are extracted. With this processing, the information processing apparatus 10 can inform the user of the fact that the list relation is present between the attributes of the object data 30.

The information processing apparatus 10 extracts the number of types of pieces of stored attribute data of respective records for each attribute with the same attribute data classified into one type. The information processing apparatus 10 outputs a determination result indicating that the inter-attribute semantic relation is in the form of hierarchy when the number of types of the pieces of attribute data for each attribute is monotonous nondecreasing in the order of arrangement of the attributes of the object data 30. With this processing, the information processing apparatus 10 can inform the user of the fact that the hierarchy relation is present between the attributes of the object data 30.

The information processing apparatus 10 extracts records about which pieces of attribute data of respective attributes are all the same among respective records. The information processing apparatus 10 outputs a determination result indicating that the semantic relation of the respective attributes is equivalence when records are extracted about which the pieces of attribute data of the respective attributes are all the same among the respective records. With this processing, the information processing apparatus 10 can inform the user of the fact that the equivalence relation is present between the attributes of the object data 30.

The information processing apparatus 10 extracts records about which part of the pieces of attribute data of the respective attributes matches and the other part of the pieces of attribute data of the respective attributes does not match among the respective records. The information processing apparatus 10 outputs a determination result indicating that the semantic relation between the respective attributes is equivalence when the records about which part of the pieces of attribute data of the respective attributes matches and the other part of the pieces of attribute data of the respective attributes does not match among the respective records are not extracted. With this processing, the information processing apparatus 10 can inform the user of the fact that the equivalence relation is present between the attributes of the object data 30. The information processing apparatus 10 can reduce difficulty in determining grounds due to many records extracted when the equivalence relation is present between the attributes of the object data 30.

The information processing apparatus 10 outputs the extracted records as grounds for determination. With this processing, the information processing apparatus 10 can support the consideration of the validity of an estimation result of the inter-attribute relation of the object data 30 by the user.

### [b] Second Embodiment

Although the above-described embodiment related to the disclosed apparatus has been described, the disclosed technology can be performed in various different forms, in addition to the above-described embodiment. The following describes another embodiment included within the scope of the present invention.

Although the above-described embodiment describes a case of performing relation estimation for all the attributes of the object data 30, the disclosed apparatus is not limited thereto, for example. Among the attributes of the object data 30, the inter-attribute relation may be estimated only for an attribute to be estimated, for example. The extracting unit 41 may extract data of records having the set, equivalence, hierarchy, and list relations between the attributes only for the attribute to be estimated. The attribute to be estimated may be designated by the user. The receiving unit 40 may cause the display unit 21 to display a screen that displays the attribute names of all the attributes of the object data 30 and receive the selection of the attribute to be estimated from the input unit 22, for example. Attributes having a certain relation may be attributes to be estimated. Related attributes may contain the same name part in their attribute names. The related attributes may be a combination of the same name part and a consecutive number, for example. In FIG. 4A through FIG. 4C, for example, the attribute name is a combination of a name part that is the same as “Attribute” and a consecutive number. In FIG. 4D, the attribute name is a combination of a name part that is the same as “Category” and a consecutive number. The consecutive number may be placed before the same name part such as “First Attribute” and “Second Attribute”. With the attributes in which the attribute name thereof is the combination of the same name part and the consecutive number as the attributes to be estimated, the extracting unit 41 may extract data of records having the set, equivalence, hierarchy, and list relations in the attributes to be estimated for each attribute to be estimated. When the object data 30 contains attributes with the attribute names “First Attribute”, “Second Attribute”, “Category 1”, and “Category 2”, for example, the extracting unit 41 extracts data of records having the set, equivalence, hierarchy, and list relations between the attributes with the attribute names “First Attribute” and “Second Attribute”. The extracting unit 41 extracts data of records having the set, equivalence, hierarchy, and list relations between the attributes with the attribute names “Category 1” and “Category 2”.

Respective components of the respective illustrated apparatuses are functionally conceptual and need not necessarily be configured physically as illustrated. In other words, a specific state of the distribution and integration of the respective apparatuses is not limited to the illustrated ones, and the whole or part thereof can be configured so as to be functionally or physically distributed or integrated in any unit in accordance with various loads or usage. The respective processing units of the receiving unit 40, the extracting unit 41, and the output unit 42 may be integrated as appropriate or separated into pieces of processing of a plurality of processing units as appropriate, for example. Furthermore, the whole or any part of the respective processing functions by the individual processing units can be implemented by a CPU and a computer program that is analyzed and executed by the CPU or be implemented as hardware by wired logic.

Relation Estimation Program

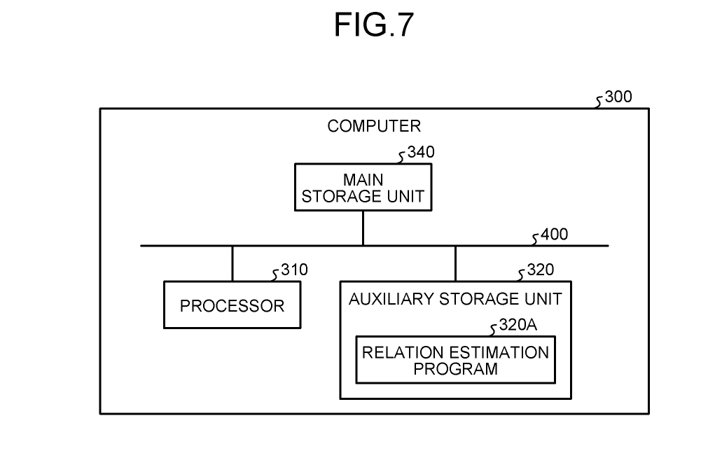

The various kinds of processing described in the embodiments can also be implemented by executing a computer program prepared in advance by a computer system such as a personal computer or a workstation. The following describes an example of the computer system that executes a computer program having functions similar to those of the above-described embodiment. FIG. 7 is a diagram of an example of a computer that executes a relation estimation program.

As illustrated in FIG. 7, this computer 300 includes a central processing unit (CPU) 310, a hard disk drive (HDD) 320, and a random access memory (RAM) 340. These units 300 to 340 are connected to each other via a bus 400.

The HDD 320 stores therein a relation estimation program 320A that exhibits functions similar to those of the receiving unit 40, the extracting unit 41, and the output unit 42 in advance. The relation estimation program 320A may be separated as appropriate.

The HDD 320 also stores therein various kinds of information. The HDD 320 stores therein an OS and various kinds of data for use in various kinds of processing, for example.

The CPU 310 reads the relation estimation program 320A from the HDD 320 and executes the relation estimation program 320A, thereby executing operations similar to those of the individual processing units of the above-described embodiment. In other words, the relation estimation program 320A executes operations similar to those of the receiving unit 40, the extracting unit 41, and the output unit 42.

The relation estimation program 320A need not necessarily be stored in the HDD 320 in advance. The relation estimation program 320A may store a computer program in a “portable physical medium” such as a compact disc read only memory (CD-ROM), a digital versatile disc (DVD), a magneto-optical disc, or an IC card to be inserted into the computer 300, for example. The computer 300 may read the computer program from these and execute the computer program.

Furthermore, the computer program is stored in “another computer (or server)” connected to the computer 300 via a public network, the Internet, a LAN, a WAN, or the like. The computer 300 may read the computer program from these and execute the computer program.

Embodiments of the present invention produce an effect of making it possible to support the estimation of an inter-attribute semantic relation.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of relation estimation, the method comprising:
extracting, from a data group that stores therein respective attributes and pieces of attribute data related to the respective attributes in association with each other about a plurality of events, data of events about which a matching relation of the pieces of attribute data among respective events satisfies a certain condition; and
based on an extraction result, outputting a determination result of an inter-attribute semantic relation.

2. The method of relation estimation according to claim 1, wherein the extracting includes extracting data of events about which pieces of attribute data match among respective events and an order of attributes in which the pieces of attribute data thereof match satisfies a certain condition from the data group.

3. The method of relation estimation according to claim 1, wherein
the extracting includes extracting data of a first event and a second event about which attribute data of a first attribute of the first event matches attribute data of a second attribute different from the first attribute of the second event and about which attribute data of the second attribute of the first event does not match the first attribute of the second event, and
the outputting includes outputting a determination result indicating that the inter-attribute semantic relation is in a form of set when the data is extracted.

4. The method of relation estimation according to claim 1, wherein
the extracting includes extracting data of events about which pieces of attribute data are exchanged in two or more attributes among respective events, and
the outputting includes outputting a determination result indicating that the inter-attribute semantic relation is in a form of list when the data is extracted.

5. The method of relation estimation according to claim 1, wherein
the extracting includes extracting the number of types of pieces of stored attribute data of respective events for each attribute with the same attribute data classified into one type, and
the outputting includes outputting a determination result indicating that the inter-attribute semantic relation is in a form of hierarchy when the number of types of the pieces of attribute data for each attribute is monotonous nondecreasing in an order of arrangement of the attributes of the data group.

6. The method of relation estimation according to claim 1, wherein
the extracting includes extracting data of events about which pieces of attribute data of respective attributes are all the same among respective events, and
the outputting includes outputting a determination result indicating that the semantic relation of the respective attributes is equivalence when data of events is extracted about which the pieces of attribute data of the respective attributes are all the same among the respective events.

7. The method of relation estimation according to claim 6, wherein
the extracting includes extracting data of events about which part of the pieces of attribute data of the respective attributes matches and another part of the pieces of attribute data of the respective attributes does not match among the respective events in place of the extracting of the data of the events, and
the outputting includes outputting a determination result indicating that the semantic relation between the respective attributes is equivalence when the data of the events about which part of the pieces of attribute data of the respective attributes matches between the respective events and the other part of the pieces of attribute data of the respective attributes does not match is not extracted.

8. The method of relation estimation according to claim 1, wherein the outputting includes outputting data of the extracted events as grounds for determination.

9. A non-transitory computer-readable recording medium having stored therein a relation estimation program that causes a computer to execute a process comprising:
extracting, from a data group that stores therein respective attributes and pieces of attribute data related to the respective attributes in association with each other about a plurality of events, data of events about which a matching relation of the pieces of attribute data among respective events satisfies a certain condition; and
based on an extraction result, outputting a determination result of an inter-attribute semantic relation.

10. An information processing apparatus comprising:
a processor that executes a process including:
extracting, from a data group that stores therein respective attributes and pieces of attribute data related to the respective attributes in association with each other about a plurality of events, data of events about which a matching relation of the pieces of attribute data among respective events satisfies a certain condition; and
based on an extraction result from the extracting unit, outputting a determination result of an inter-attribute semantic relation.
